(19) United States
(12) Patent Application Publication
(10) Pub. No.: US 2022/0172481 A1
(43) Pub. Date: Jun. 2, 2022

(54) AUTOMATED SOCIAL DISTANCE MONITORING USING A DEPTH-SENSING CAMERA SYSTEM

(71) Applicant: Covidien LP, Mansfield, MA (US)

(72) Inventors: Paul S. Addison, Edinburgh (GB); Anthony P. Addison, Edinburgh (GB)

(21) Appl. No.: 17/536,364

(22) Filed: Nov. 29, 2021

Related U.S. Application Data
(60) Provisional application No. 63/119,143, filed on Nov. 30, 2020.

(51) Int. Cl. G06V 20/52; G06T 7/70; G08B 25/01

(52) U.S. Cl. CPC G06V 20/52; G06T 7/70; G06T 2207/30232; G06T 2207/30196; G08B 25/016

(57) ABSTRACT

Automated systems and methods for social distance monitoring are described, utilizing a depth camera configured with a field of view having at least two objects of interest therein and configured to generate depth camera data for a processor that determines a distance between the objects of interest as compared with social distancing rules to assess compliance with such social distancing rules.

### CROSS-REFERENCE TO RELATED APPLICATIONS

This application claims the benefit of U.S. Provisional Application Ser. No. 63/119,143, filed Nov. 30, 2020, which is incorporated herein by reference in its entirety.

### FIELD

The present technology is generally related to automated social distance monitoring using a depth-sensing camera system, for example for pandemic management.

### BACKGROUND

Depth cameras have found use in the medical field, for example in monitoring of respiratory physiological information, such as respiration rate, tidal volume, minute volume, apnea, etc., as well as for providing patient contextual information, such as posture, presence in bed, interaction with clinicians, etc. While such depth cameras have good application in those fields, the present application recognizes that other uses may have utility.

### SUMMARY

The techniques of this disclosure generally relate to automated systems and methods for social distance monitoring utilizing a depth camera. In exemplary embodiments, a depth camera is configured to monitor social distancing between objects of interest in a video stream to identify whether social distance rules are being followed.

In one aspect, the present disclosure provides a method for social distance monitoring use a depth camera and a processor that determines distances between individuals in a video image or stream. Such method may be used to generate an alarm when social distance rules are not being followed, to provide a flag indicating that personal protective equipment (PPE) should be worn, and/or to provide social distance metrics for further analysis.

In another aspect, the disclosure provides a system for social distance monitoring using one or more depth cameras and a processor that provides analysis, alarms and/or metrics.

In another aspect, the disclosure provides systems and methods utilizing multiple depth cameras to determine distances between pairs of individuals.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a diagram showing a system for social distance monitoring using a depth camera;

FIG. 2 is a conceptual diagram that illustrates determination of distances between individuals in a scene utilizing a depth camera;

FIG. 3 is a flow chart describing a method for social distance monitoring using a depth camera;

FIG. 4 is a conceptual diagram that illustrates determination of distances between three individuals in a scene utilizing a depth camera;

FIG. 5 is a conceptual diagram that illustrates determination of distances between a caregiver and a patient utilizing a depth camera; and

FIG. 6 is a conceptual diagram that illustrates switching to an alternate depth camera during obstruction of the field of view for a first depth camera.

### DETAILED DESCRIPTION

As we have noted above, the present disclosure describes automated systems and methods for social distance monitoring utilizing a depth camera. Such systems and methods may find application in hospital settings, in general, or in any setting where distancing between individuals or groups of people are important. One exemplary application includes pandemic management, such as for COVID-19 management.

In exemplary embodiments, a depth camera is configured to monitor social distancing between objects of interest in a video stream to identify whether social distance rules are being followed. These social distance rules may be unique, related to a particular camera location, related to a particular communicable virus or other contractable condition, etc. Additionally, these rules may be set or be changeable.

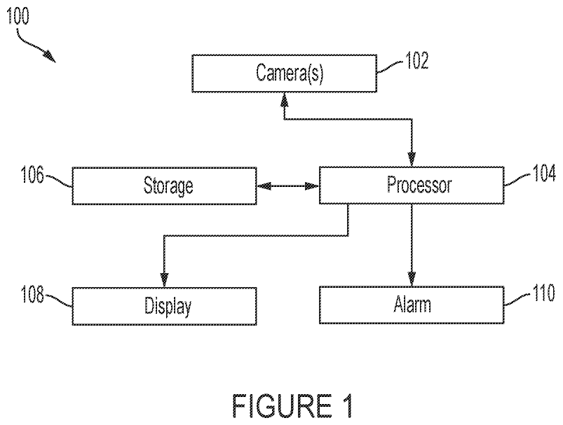

In exemplary embodiments, the objects of interest include at least one human subject/individual, though objects of interest can include can also include areas of interest or other objects (for example, areas that would require cleaning after assessment of social distance rules with regard to compliance). For convenience, various examples such as those referred to with regard to FIGS. 1-6, refer to individuals or subjects, though it should be recognized that the present disclosure contemplates one or more tracked objects of interest be non-human, for example a surface or area of interest.

In one aspect, the present disclosure provides a system for social distance monitoring use a depth camera and a processor that determines distances between individuals in a video image or stream. Referring to FIG. 1, the system 100 for social distance monitoring includes at least one depth camera 102 that is configured to detect distances to objects of interest and to discern relative angles between objects. The data and information from the depth camera(s) is received and transmitted (via wired or wireless transmission) to a processor 104 (as part of a computing system, server, etc.), which is configured to calculate distance between objects of interest as compared with social distance rules, as will be described in more detail below. In exemplary embodiments, the processor is also configured to provide such calculations over time. The processor is optionally also configured to provide control functions for the camera(s). Data from the camera(s) and/or from processor calculations is optionally stored in memory/storage 106. Additionally, data from the camera(s) and/or from processor calculations is optionally transmitted for display on the display device 108. The processor is also optionally connected to an alarm 110, which may activate during certain lapses in social distancing compliance.

In another aspect, the disclosure provides a method for social distance monitoring using one or more depth cameras and a processor that provides analysis, alarms and/or metrics.

Such method may be used to generate an alarm when social distance rules are not being followed, to provide a flag indicating that personal protective equipment (PPE) should be worn, and/or to provide social distance metrics for further analysis.

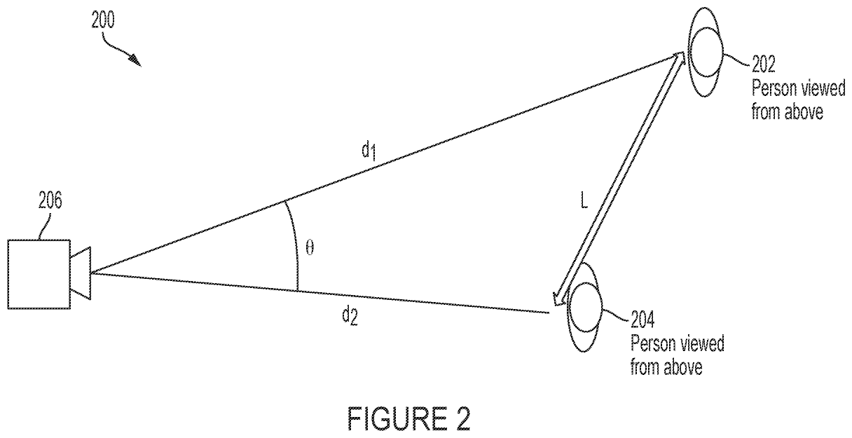

FIG. 2 illustrates at 200 an exemplary system and method for determining distances between individuals 202, 204 in the scene of a video image or stream utilizing a depth camera 206. In the illustrated exemplary embodiment, two individuals are shown in the camera view. In this example, social distancing rules require a separation between subjects of:

$${L}_{min} ( where {L}_{min} may be 1 m , 2 m , etc . )$$

In FIG. 2, the two subjects are viewed from above and are at distances d₁ and d₂ from the camera, separated by an angle θ. To calculate the distance L between the two subjects, the following cosine rule may be used:

$${L}^{2} = {d}_{1}^{2} + {d}_{2}^{2} - 2 {d}_{1} {d}_{2} cos ( θ )$$

In exemplary systems and methods, distance L may be compared with distance rule threshold ₘᵢₙ. If distance L is less than Lₘᵢₙ, the system or method may generate a flag, generate an alarm, etc. Additionally, the time during which the social distance rule is being compromised (while distance L is less than Lₘᵢₙ) may be recorded. Further, the frequency of compromises may be logged separate from or along with times of compromise.

In exemplary embodiments, social distancing rules may also require plural threshold values be crossed in order to trigger one or more flags or alarms, e.g., a calculated L value less than Lₘᵢₙ for a specified minimum amount of time (e.g., 1 minute, 5 minutes, 10 minutes, 15 minutes, or any set value below, between or above those exemplary times).

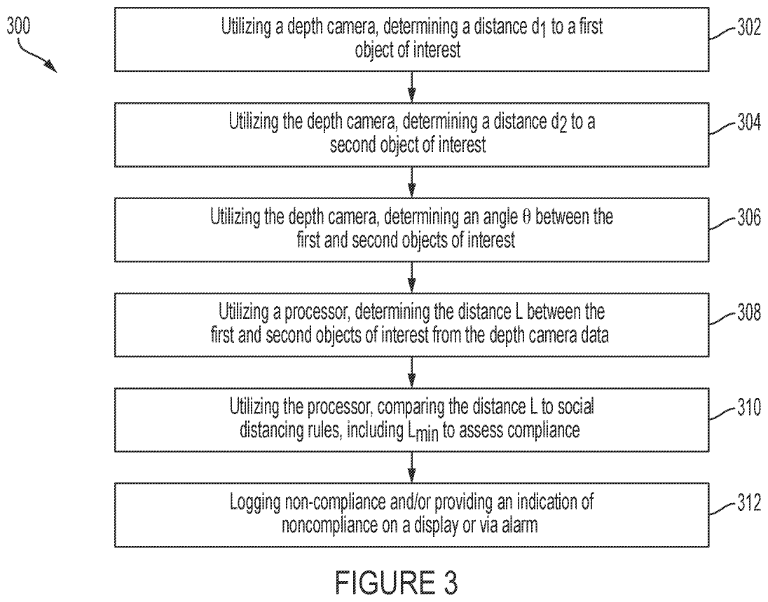

Accordingly, an exemplary method for social distance monitoring is illustrated generally at 300 in the flow chart of FIG. 3, including: utilizing a depth camera, determining a distance d₁ to a first object of interest at step 302; utilizing the depth camera, determining a distance d₂ to a second object of interest at step 304; utilizing the depth camera, determining an angle θ between the first and second objects of interest at step 306; utilizing a processor, determining the distance L between the first and second objects of interest from the depth camera data at step 308; utilizing the processor, comparing the distance L to social distancing rules, including Lₘᵢₙ to assess compliance at step 310; and logging non-compliance and/or providing an indication of noncompliance on a display or via alarm at step 312.

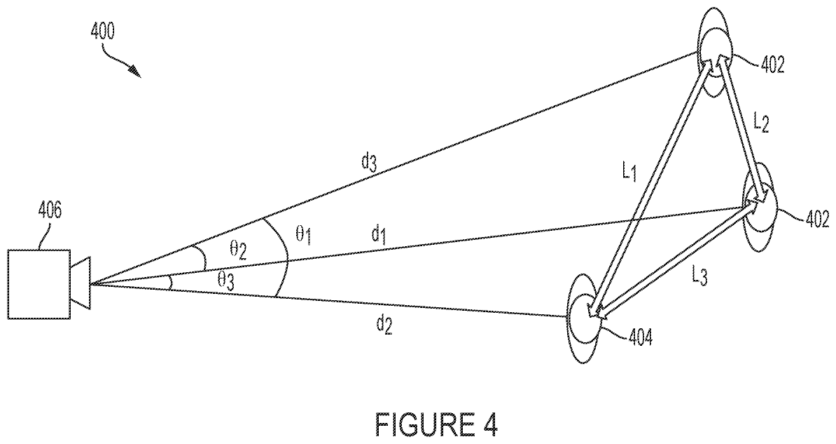

In further exemplary systems and methods, more than two people may be assessed by examining distance between pairs of individuals, for example with regard to FIG. 4, which shows three people within the field of view of a depth camera.

FIG. 4 illustrates another exemplary system and method generally at 400, wherein a depth camera 406 and a processor assesses a scene with three individuals, 402, 404, 408. As in FIG. 2, the subjects are viewed from above and are at distances d₁, d₂ and d₃ from the camera, separated by angles θ₁, θ₂ and θ₃. To calculate the distances L₁, L₂ and L₃ between the subjects, the following cosine rules may be used:

$${L}_{1}^{2} = {d}_{3}^{2} + {d}_{2}^{2} - 2 {d}_{3} {d}_{2} cos ( {θ}_{1} )$$

$${L}_{2}^{2} = {d}_{3}^{2} + {d}_{1}^{2} - 2 {d}_{3} {d}_{1} cos ( {θ}_{2} )$$

$${L}_{3}^{2} = {d}_{1}^{2} + {d}_{2}^{2} - 2 {d}_{1} {d}_{2} cos ( {θ}_{3} )$$

As above, various measured distances between individuals, in this case one or more of L₁, L₂ and L₃ may be compared with social distancing rules, e.g., having a threshold distance Lₘᵢₙ (where Lₘᵢₙ may be 1 m, 2 m, etc.). A flag may be logged or transmitted by the processor, one or more alarms may be generated, etc., where one or more of L₁, L₂ and L₃ are less than Lₘᵢₙ.

Measured distances between individuals (L₁, L₂ and L₃ in the case of three individuals; Lₙ in the case of n individuals) may be measured once, measured plural times, measured intermittently (e.g., measured with a given frequency) or measured continually in order to check for social distance compliance with social distancing rules.

In exemplary systems and methods, the distance(s) L between individuals may be defined as the distance between the center of the torso of each person. Alternately, it may be defined as the distance between the head or mouth of each person; or it may be between any part of the body of each person (hand, arm, foot, head, mouth, etc.) to any other part of the body. The distance(s) L may also be between the nearest part of each person's body.

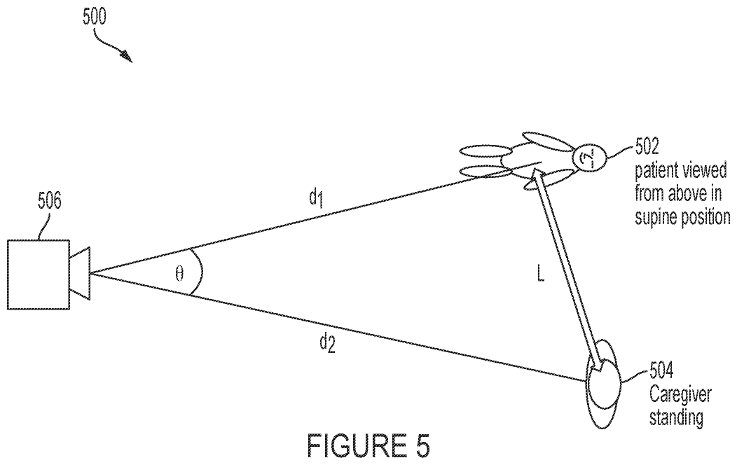

In a hospital environment, objects of interest may include a patient and a caregiver, with a processor measuring the distance from a patient to a caregiver. When the caregiver gets within the social distance threshold, the alarm may sound to inform the caregiver to use PPE equipment. An example of this is shown in FIG. 5 at 500, where a patient 502 is shown in the supine position and a caregiver 504 is shown standing. Distance L is worked out the same way as explained with regard to FIG. 2. In exemplary embodiments, as shown in FIG. 5, distance L is taken between the center of the chest of each individual.

In exemplary embodiments, a range of social distancing metrics may be generated and logged over time. This may help with measuring compliance with social distancing measures. For example, the system and method can compute the average L, the minimum L, the time during which the distances were less than Lₘᵢₙ, etc.

The present disclosure recognizes that, in the caregiver setting, there are many instances where L is less than Lₘᵢₙ, for example when the caregiver is attending to a patient where close contact is necessary, for example feeding, drawing blood, administering a drug, washing, measuring a physiological parameter such as temperature, etc. In this case, the generation of metrics may help to better inform the overall management of the patient.

For example, the system and method may identify or be programmed with social distancing rules to account for correlations between the number of times Lₘᵢₙ is violated and the spread of a disease. Additionally, the system and method may identify or have social distancing rules that are programmed to account for correlations between the amount of time that L is below Lₘᵢₙ and infection rates.

In exemplary embodiments where timing of a lack of compliance (as relating to distance) is performed, the system and method may delay an alarm until a pre-set period has elapsed.

In further exemplary systems and methods, social distancing rules may specify Lₘᵢₙ according to the disease. For example, some diseases are passed by touch, some are airborne. In exemplary embodiments, the system and method utilizes a look up table relating an identified disease (e.g., specifying an Lₘᵢₙ and/or other rules) to calibrate the system.

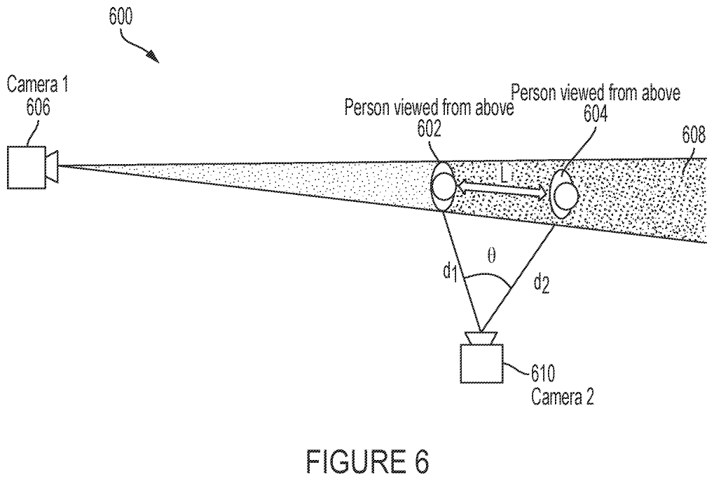

In further exemplary systems and methods, multiple cameras are provided to mitigate against issues related to the blocking of the field of view. FIG. 6 illustrates such an exemplary system and method at 600.

FIG. 6, depicts an exemplary scenario whereby a person 602 is blocking the field of view of camera 606 so that it cannot see a second person 604. As is illustrated in FIG. 6, camera 606 cannot detect anything in shaded region 608.

However, differently placed camera 610 has an unobstructed view of person 602 and person 604. With such a differently placed camera, a processor can calculate the distance L between the two people using the same method as described with regard to FIG. 2 utilizing camera 610 rather than camera 606.

The system and method described with regard to FIG. 6 may be extended to any number of cameras to cope with large numbers of people in a given space or venue. In further exemplary embodiments, the processor automatically switches to one or more alternate cameras for any obstructed objects of interest.

In another aspect, the disclosure provides systems and methods utilizing multiple depth cameras to determine distances between pairs of individuals. These distances between individual pairs may be averaged to find a best estimate. This average may be weighted to account for the quality of the measurement. For example, if one of the measurements has more noise in the distance estimate signal, it may be weighted lower in a weighted average.

The present disclosure relates to use of any camera system, or combination of camera systems, where a distance or depth can be measured, including infrared (IR) and Red/Green/Blue (RGB). Additionally, the camera(s) may generate distance or depth data independently, or with the assistance of one or more processors in communication therewith.

As we have noted above, the presently described system and method contemplates any type of objects of interest, inclusive of people, objects and areas of interest, for example where for example a caregiver or patient may come into contact (or be within an Lₘᵢₙ) with a surface.

As we have also noted, in exemplary embodiments, areas of interest may include objects or areas with a surface that needs to be cleaned if compliance is compromised. Such a need may be indicated on a display screen by, for example, changing the color of the object or surface. In exemplary embodiments, information on a length of time a virus, etc., can survive on specific surfaces may be included in the method, whereby after this ‘survival time’ the surface may be indicated as safe again or lower priority for cleaning.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A method for automated social distance monitoring, comprising:
providing at least one depth camera with a field of view having at least two objects of interest therein;
with the at least one depth camera, determining depth camera data relating to the at least two objects of interest, including: a distance d₁ to a first object of interest; a distance d₂ to a second object of interest; and an angle θ between the first object of interest and the second object of interest;
with a processor, configured to receive such depth camera data:
determining a distance L between the first object of interest and the second object of interest from the depth camera data utilizing the processor; and
comparing the distance L to at least one social distancing rule that includes a predetermined threshold minimum distance Lₘᵢₙ for compliance with the at least one social distance rule; and
if the distance L between the first object of interest and the second object of interest is less than the predetermined threshold minimum distance Lₘᵢₙ, logging non-compliance in memory, providing an indication of noncompliance on a display or activating an alarm.

2. A method in accordance with claim 1, wherein at least one object of interest is a human.

3. A method in accordance with claim 1, wherein at least one object of interest is an object or surface.

4. A method in accordance with claim 1, wherein the at least one social distancing rule is selected from plural stored social distancing rules relating to a disease type or characteristic.

5. A method in accordance with claim 1, wherein at least one social distancing rule indicates non-compliance if a measured distance L is less than the predetermined threshold minimum distance Lₘᵢₙ for more than a predetermined minimum period of time.

6. A method in accordance with claim 1, wherein noncompliance results in the generation of a flag by the processor, which triggers an alarm.

7. A method in accordance with claim 1, wherein noncompliance is illustrated on a display.

8. A method in accordance with claim 7, wherein at least one object of interest includes a surface, and wherein noncompliance is illustrated on the display by indicating noncompliance relative to the surface.

9. A method in accordance with claim 1, wherein plural depth cameras are utilized, and wherein the processor automatically switches from a first depth camera to a second depth camera if a first object of interest blocks the field of view of the first depth camera such that it cannot measure the distance to a second object of interest or angle between the first object of interest and the second object of interest.

10. A method in accordance with claim 9, wherein the processor is configured to access data from more than one depth camera simultaneously to automatically identify objects of interest, to calculate distances between objects of interest using respective depth cameras and to automatically track compliance of plural objects of interest.

11. A system for automated social distance monitoring, comprising:
a depth camera configured with a field of view having at least two objects of interest therein and configured to generate depth camera data relating to the at least two objects of interest, including: a distance d₁ to a first object of interest; a distance d₂ to a second object of interest; and an angle θ between the first object of interest and the second object of interest;
a processor, configured to receive such depth camera data and to:
determine a distance L between the first object of interest and the second object of interest from the depth camera data;
compare the distance L to at least one social distancing rule that includes a predetermined threshold minimum distance Lₘᵢₙ for compliance with the at least one social distance rule; and
if the distance L between the first object of interest and the second object of interest is less than the predetermined threshold minimum distance Lₘᵢₙ, logging non-compliance in memory, providing an indication of noncompliance on a display or activating an alarm.

12. A system in accordance with claim 11, wherein at least one object of interest is a human.

13. A system in accordance with claim 11, wherein at least one object of interest is an object or surface.

14. A system in accordance with claim 11, wherein the at least one social distancing rule is selected from plural stored social distancing rules relating to a disease type or characteristic.

15. A system in accordance with claim 11, wherein at least one social distancing rule indicates non-compliance if a measured distance L is less than the predetermined threshold minimum distance Lₘᵢₙ for more than a predetermined minimum period of time.

16. A system in accordance with claim 11, wherein noncompliance results in the generation of a flag by the processor, which triggers an alarm.

17. A system in accordance with claim 11, wherein noncompliance is illustrated on a display.

18. A system in accordance with claim 17, wherein at least one object of interest includes a surface, and wherein noncompliance is illustrated on the display by indicating noncompliance relative to the surface.

19. A system in accordance with claim 11, wherein plural depth cameras are provided, and wherein the processor is configured to automatically switch from a first depth camera to a second depth camera if a first object of interest blocks the field of view of the first depth camera such that it cannot measure the distance to a second object of interest or angle between the first object of interest and the second object of interest.

20. A system in accordance with claim 19, wherein the processor is configured to access data from more than one depth camera simultaneously to automatically identify objects of interest, to calculate distances between objects of interest using respective depth cameras and to automatically track compliance of plural objects of interest.
